(19) United States
(12) Patent Application Publication
(10) Pub. No.: US 2008/0238313 A1
(43) Pub. Date: Oct. 2, 2008

(54) PLASMA DISPLAY PANEL

(76) Inventor: Jung-Suk Song, Suwon-si (KR)

Correspondence Address: CHRISTIE, PARKER & HALE, LLP, PO BOX 7068, PASADENA, CA, 91109-7068, US

(21) Appl. No.: 11/830,715

(22) Filed: Jul. 30, 2007

(30) Foreign Application Priority Data
Mar. 28, 2007 (KR) 10-2007-0030367

(51) Int. Cl. H01J 1/62

(52) U.S. Cl. 313/582

(57) ABSTRACT

A plasma display panel includes: a first substrate and a second substrate facing the first substrate, the first and second substrates defining a discharge space therebetween; and barrier ribs between the first and second substrates and defining non-discharge and discharge regions at the discharge space. The barrier ribs include: first ribs and second ribs adjacent the first ribs, the first and second ribs defining the non-discharge regions; third ribs adjacent the second ribs, the second and third ribs defining first discharge regions of the discharge regions, the first regions being adjacent the non-discharge regions, and the third ribs having a width different from that of the second ribs; and fourth ribs adjacent the first ribs, the first and fourth ribs defining second discharge regions of the discharge regions, the second regions being adjacent the non-discharge regions, and the fourth ribs having a width different from that of the first ribs.

### CROSS-REFERENCE TO RELATED PATENT APPLICATION

This application claims priority to and the benefit of Korean Patent Application No. 10-2007-0030367, filed on Mar. 28, 2007, in the Korean Intellectual Property Office, the entire content of which is incorporated herein by reference.

### BACKGROUND OF THE INVENTION

1. Field of the Invention

The present invention relates to a plasma display panel.

2. Description of the Related Art

In a conventional plasma display panel, a barrier rib structure formed between upper and lower panels defines a plurality of discharge cells, phosphor layers are coated on walls of the barrier rib structure, and each of the discharge cells is filled with a main discharge gas such as neon (Ne) gas, helium (He) gas, or a mixture gas of Ne gas and He gas, and an inert gas that contains a small amount of xenon (Xe) gas. When a high frequency voltage is applied to the plasma display panel, vacuum ultraviolet rays are generated from the inert gas, and the vacuum ultraviolet rays excite the phosphor layers to emit visible light. Thus, an image is realized using the visible light. Plasma display panels are thin and lightweight, and thus are expected to be the next generation of large screen display apparatuses.

FIG. 1 is a plan view of the arrangements of a barrier rib structure and discharge electrodes of a conventional plasma display panel.

Referring to FIG. 1, a first barrier rib 181, a second barrier rib 182, a third barrier rib 183, and a fourth barrier rib 184 are horizontally disposed parallel to each other on a lower panel. Fifth barrier ribs 185 are disposed to perpendicularly cross the first through fourth barrier ribs 181 through 184 on the lower panel.

Non-discharge regions 193 are formed by the first barrier rib 181, the second barrier rib 182, and the fifth barrier ribs 185, a first discharge region 191 is formed by the first barrier rib 181, the fourth barrier rib 184, and the fifth barrier ribs 185, and a second discharge region 192 is formed by the second barrier rib 182, the third barrier rib 183, and the fifth barrier ribs 185.

An upper panel includes a first electrode 121 and a fourth electrode 124 that generate a discharge in the first discharge region 191, and a second electrode 122 and a third electrode 123 that generate a discharge in the second discharge region 192.

When the lower panel and the upper panel are placed together, the first electrode 121 (a transparent electrode 121t and a bus electrode 121b) is placed at a location corresponding to the first barrier rib 181, the second electrode 122 (a transparent electrode 122t and a bus electrode 122b) is placed at a location corresponding to the second barrier rib 182, the third electrode 123 (a transparent electrode 123t and a bus electrode 123b) is placed at a location corresponding to the third barrier rib 183, and the fourth electrode 124 (a transparent electrode 124t and a bus electrode 124b) is placed at a location corresponding to the fourth barrier rib 184.

However, as the number of discharge regions is increased in order to improve image quality, a cell pitch is reduced, and as a result, misalignments between the barrier ribs and the electrodes may occur frequently. In FIG. 1, a size of a first area S1, which is an area of the first electrode 121 exposed in the first discharge region 191, is different from a size of a second area S2, which is an area of the second electrode 122 exposed in the second discharge region 192, since the discharge electrodes are not correctly placed with respect to the barrier ribs.

Accordingly, a relatively low (or weak) discharge occurs in the second discharge region 192 compared to the first discharge region 191, that is, a non-uniform discharge occurs in every other line of the conventional plasma display panel.

### SUMMARY OF THE INVENTION

An aspect of the present invention is directed to providing a plasma display panel having increased reliability by preventing (or reducing) occurrences of a non-uniform discharge in every other line.

According to an exemplary embodiment of the present invention, a plasma display panel includes: a first substrate and a second substrate facing the first substrate, the first and second substrates defining a discharge space therebetween; and a plurality of barrier ribs between the first and second substrates and defining a plurality of non-discharge regions and a plurality of discharge regions at the discharge space. The barrier ribs include: a plurality of first barrier ribs and a plurality of second barrier ribs adjacent to the first barrier ribs, the first and second barrier ribs defining the non-discharge regions; a plurality of third barrier ribs adjacent to the second barrier ribs, the second and third barrier ribs defining first discharge regions of the discharge regions, the first discharge regions being adjacent to the non-discharge regions, and the third barrier ribs having a width different from a width of the second barrier ribs; and a plurality of fourth barrier ribs adjacent to the first barrier ribs, the first and fourth barrier ribs defining second discharge regions of the discharge regions, the second discharge regions being adjacent to the non-discharge regions, and the fourth barrier ribs having a width different from a width of the first barrier ribs.

The width of the first barrier ribs may be smaller than the width of the fourth barrier ribs.

The width of the second barrier ribs may be smaller than the width of the third barrier ribs.

The first barrier ribs, the second barrier ribs, the third barrier ribs, and the fourth barrier ribs may be in parallel to each other.

The barrier ribs may further include a plurality of fifth barrier ribs crossing the first barrier ribs, the second barrier ribs, the third barrier ribs, and the fourth barrier ribs.

According to another exemplary embodiment of the present invention, a plasma display panel includes: a first substrate and a second substrate facing the first substrate, the first and second substrates defining a discharge space therebetween; a plurality of barrier ribs between the first and second substrates and defining a plurality of non-discharge regions and a plurality of discharge regions at the discharge space; and a plurality of discharge electrodes for generating discharges at the discharge regions in accordance with an applied voltage. The plurality of barrier ribs include: a plurality of first barrier ribs and a plurality of second barrier ribs adjacent to the first barrier ribs, the first and second barrier ribs defining the non-discharge regions; a plurality of third barrier ribs adjacent to the second barrier ribs, the second and third barrier ribs defining first discharge regions of the discharge regions, the first discharge regions being adjacent to the non-discharge regions, and the third barrier ribs having a width different from a width of the second barrier ribs; and a plurality of fourth barrier ribs adjacent to the first barrier ribs, the first and fourth barrier ribs defining second discharge regions of the discharge regions, the second discharge regions being adjacent to the non-discharge regions, and the fourth barrier ribs having a width different from a width of the first barrier ribs. The plurality of discharge electrodes include: a plurality of first discharge electrodes for generating the discharges at the first discharge regions; and a plurality of second discharge electrodes for generating the discharges at the second discharge regions, the second discharge electrodes being in parallel to the first discharge electrodes, wherein portions of the first discharge electrodes exposed at the first discharge regions have a size different from a size of portions of the second discharge electrodes exposed at the second discharge regions.

The width of the first barrier ribs may be smaller than the width of the fourth barrier ribs.

The width of the second barrier ribs may be smaller than the width of the third barrier ribs.

The first and second discharge electrodes may include Y electrodes to which substantially identical voltage waveforms are applied during a sustain period.

Portions of the second discharge electrodes may be exposed at the non-discharge regions.

The plurality of discharge electrodes may further include a plurality of third discharge electrodes for generating the discharges at the second discharge regions. The applied voltage may be alternately applied to the second discharge electrodes and the third discharge electrodes. The third discharge electrodes may include X electrodes.

The plurality of discharge electrodes may further include a plurality of fourth discharge electrodes for generating the discharges at the first discharge regions. The applied voltage may be alternately applied to the first discharge electrodes and the fourth discharge electrodes. The fourth discharge electrodes may be X electrodes.

Portions of the third discharge electrodes exposed at the second discharge regions may have a surface area different from a surface area of portions of the fourth discharge electrodes exposed at the first discharge regions.

### BRIEF DESCRIPTION OF THE DRAWINGS

The above and other features and aspects of the present invention will become more apparent by describing in detail exemplary embodiments thereof with reference to the attached drawings in which:

FIG. 1 is a plan view of the arrangements of a barrier rib structure and discharge electrodes of a conventional plasma display panel;

FIG. 2 is a partial cutaway exploded perspective view of a plasma display panel according to an embodiment of the present invention; and

FIG. 3 is a plan view of the arrangements of a barrier rib structure and discharge electrodes of a plasma display panel according to an embodiment of the present invention.

### DETAILED DESCRIPTION

The present invention will now be described more fully with reference to the accompanying drawings in which exemplary embodiments of the invention are shown.

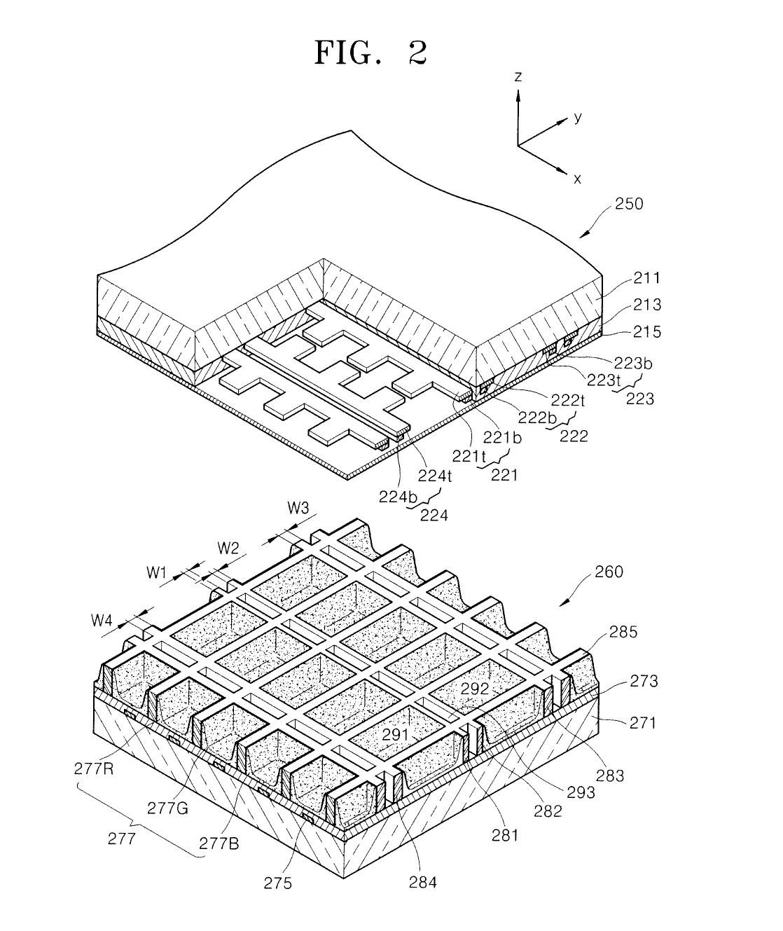

FIG. 2 is a partial cutaway exploded perspective view of a plasma display panel (PDP) according to an embodiment of the present invention.

Referring to FIG. 2, the plasma display panel includes an upper panel 250 and a lower panel 260.

The upper panel 250 includes a first substrate 211, an upper dielectric layer 213, a protective layer 215, and a plurality of discharge electrodes.

The first substrate 211 is formed of a material having a high optical transmittance, for example, glass or soda lime glass. The first substrate 211 can be colored to increase bright room contrast by reducing external light reflection.

A plurality of discharge electrodes are formed on the first substrate 211.

The discharge electrodes include a first electrode 221, a second electrode 222, a third electrode 223, and a fourth electrode 224 disposed in parallel to each other in an X direction, e.g., an X direction of the PDP (see FIG. 2). The first electrode 221 and the fourth electrode 224 face each other in a first discharge region 291, and the second electrode 222 and the third electrode 223 face each other in a second discharge region 292.

Each of the first through fourth electrodes 221 through 224 includes a transparent electrode and a bus electrode. More specifically, the first electrode 221 includes a first transparent electrode 221t and a first bus electrode 221b, the second electrode 222 includes a second transparent electrode 222t and a second bus electrode 222b, the third electrode 223 includes a third transparent electrode 223t and a third bus electrode 223b, and the fourth electrode 224 includes a fourth transparent electrode 224t and a fourth bus electrode 224b.

The first through fourth transparent electrodes 221t, 222t, 223t, and 224t generate discharges and maintain the discharges in discharge regions, and can be formed of a material having high visible light transmittance and low resistance (but relatively high resistance with respect to the bus electrodes), for example, indium tin oxide (ITO). Each of the first through fourth transparent electrodes 221t, 222t, 223t, and 224t includes a straight line portion that extends in the X direction and protrusion portions extending in a Y direction from the straight line portion. Protrusion portions of a pair of the transparent electrodes that face each other are disposed in each of the discharge regions. That is, the protrusion portions of the first electrode 221 and the fourth electrode 224 face each other in the first discharge region 291, and the protrusion portions of the second electrode 222 and the third electrode 223 face each other in the second discharge region 292.

Substantially equal voltages can be applied to the plurality of discharge regions by the compensation of the first through fourth bus electrodes 221b, 222b, 223b, and 224b for the relatively high resistance of the first through fourth transparent electrodes 221t, 222t, 223t, and 224t. The first through fourth bus electrodes 221b, 222b, 223b, and 224b can be formed of, for example, Cr, Cu, or Al.

The upper dielectric layer 213 is formed on the first substrate 211 to cover the first through fourth electrodes 221, 222, 223, and 224, to sustain a glow discharge, and to reduce a discharge voltage formed through the accumulation of wall charges. The upper dielectric layer 213 may have a high withstanding voltage and a high visible light transmittance to increase discharge efficiency.

The protective layer 215 is formed on the upper dielectric layer 213 to protect the upper dielectric layer 213 from collision by charged particles and to reduce a discharge voltage by emitting secondary electrons. In one embodiment, the protective layer 215 is formed of magnesium oxide (MgO), or MgO doped with a rare-earth element.

The lower panel 260 includes a second substrate 271, a lower dielectric layer 273, address electrodes 275, a plurality of barrier ribs, and a plurality of phosphor layers.

Similar to the first substrate 211, the second substrate 271 can be formed of a material having high optical transmittance, for example, glass or soda lime glass. Also, the second substrate 271 can be colored to increase bright room contrast by reducing external light reflection.

The lower dielectric layer 273 is formed on the second substrate 271 to cover the address electrodes 275. The lower dielectric layer 273 can be formed of a material having high dielectric breakdown strength, and, in the case of a top emission type PDP, can be formed of a material having high optical reflectance to increase light emission efficiency. The lower dielectric layer 273 can protect the address electrodes 275 from collision by charged particles.

The address electrodes 275 extend in the Y direction, e.g., the Y direction of the PDP (see FIG. 2) on the second substrate 271, and a voltage is applied to the address electrodes 275 to generate address discharges by which discharge regions, where light is to be emitted, are selected. The address electrodes 275 can be formed of a metal having high electrical conductivity such as Cr, Cu, or Al so that substantially equal voltages can be applied to the plurality of discharge regions together with the first through fourth bus electrodes 221b, 222b, 223b, and 224b.

In a PDP according to an embodiment of the present invention, the barrier ribs are disposed on the lower dielectric layer 273 to form a plurality of non-discharge regions and a plurality of discharge regions.

The barrier ribs include first barrier ribs 281 and second barrier ribs 282, and further include fourth barrier ribs 284 that define the first discharge regions 291 of the plurality of discharge regions together with the first barrier ribs 281. The first discharge regions 291 are disposed adjacent to non-discharge regions 293. Also, the barrier ribs include third barrier ribs 283 that define the non-discharge regions 293 and the second discharge regions 292 adjacent to the non-discharge regions 293 together with the second barrier ribs 282. The first barrier ribs 281, the second barrier ribs 282, the third barrier ribs 283, and the fourth barrier ribs 284 are disposed in parallel to each other in the X direction.

Also, the barrier ribs further include fifth barrier ribs 285 that cross the first through fourth barrier ribs 281 through 284, and more specifically, extend in the Y direction. Accordingly, the barrier ribs in the present embodiment are disposed in a matrix format, and, thus, form non-discharge regions 293 and the first and second discharge regions 291 and 292 having rectangular shapes.

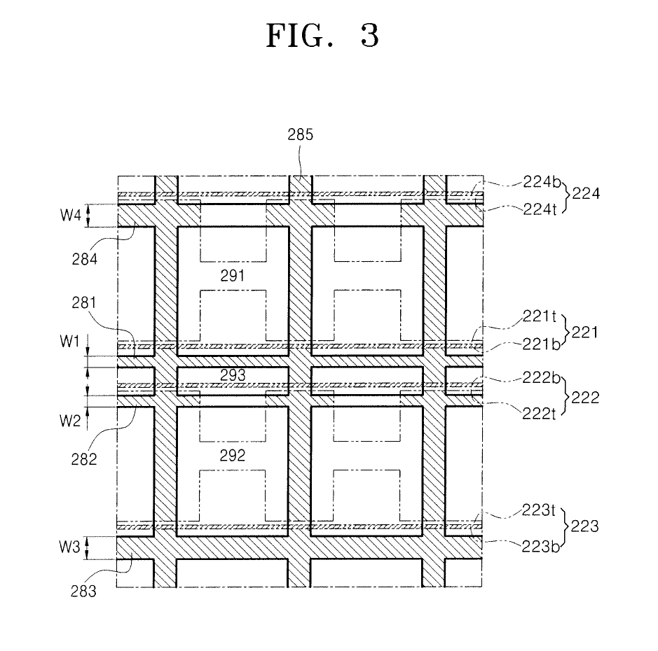

When the upper panel 250 and the lower panel 260 are placed together, the discharge electrodes are disposed on the barrier ribs. The arrangements of the barrier ribs and the discharge electrodes, according to one embodiment, will now be described with reference to FIG. 3.

Referring to FIG. 3, the first barrier rib 281, the second barrier rib 282, the third barrier rib 283, and the fourth barrier rib 284 are disposed in parallel to each other, and the fifth barrier ribs 285 that cross the first through fourth barrier ribs 281 through 284 are disposed to form a matrix type barrier rib structure.

The first barrier rib 281 and the second barrier rib 282 form the non-discharge region 293, the first barrier rib 281 and the fourth barrier rib 284 form the first discharge region 291, and the second barrier rib 282 and the third barrier rib 283 form the second discharge region 292. Accordingly, the non-discharge region 293 is disposed between the first discharge region 291 and the second discharge region 292.

A plurality of discharge electrodes are disposed at the discharge regions defined by the barrier ribs. More specifically, the first electrode 221 and the fourth electrode 224 are disposed at the first discharge region 291, and the second electrode 222 and the third electrode 223 are disposed at the second discharge region 292. As such, a discharge is generated in the first discharge region 291 by applying a voltage to the first electrode 221 and the fourth electrode 224, and a discharge is generated in the second discharge region 292 by applying a voltage to the second electrode 222 and the third electrode 223.

The first electrode 221 and the second electrode 222, to which substantially identical voltage waveforms are applied during a sustain period, can be Y electrodes (e.g., scan electrodes). Also, the third electrode 223 and the fourth electrode 224, to which substantially identical voltage waveforms are applied during the sustain period, can be X electrodes (e.g., sustain electrodes). Since sustain discharges are generated by alternately applying a voltage to the X electrode and the Y electrode during the sustain period, the voltage is alternately applied to the first electrode 221 and the fourth electrode 224, and the voltage is alternately applied to the second electrode 222 and the third electrode 223.

The first through fourth electrodes 221, 222, 223, and 224 respectively include the first through fourth transparent electrodes 221t, 222t, 223t, and 224t and respectively include the first through fourth bus electrodes 221b, 222b, 223b, and 224b. Each of the first through fourth transparent electrodes 221t, 222t, 223t, and 224t includes straight line portions that extend in parallel to the first through fourth barrier ribs 281 through 284 and protrusion portions protruding from the straight line portions. The protrusion portions that are disposed in (or at) the first discharge region 291 face each other, and the protrusion portions that are disposed at the second discharge region 292 face each other. More specifically, the protrusion portions of the first electrode 221 and the protrusion portions of the fourth electrode 224 are symmetrically disposed at the first discharge region 291, and the protrusion portions of the second electrode 222 and the protrusion portions of the third electrode 223 are symmetrically disposed at the second discharge region 292.

In order to increase the light emission efficiency of the PDP, the first electrode 221, particularly, the first bus electrode 221b, is located at a location corresponding to the first barrier rib 281, the second bus electrode 222b is located at a location corresponding to the second barrier rib 282, the third bus electrode 223b is located at a location corresponding to the third barrier rib 283, and the fourth bus electrode 224b is located at a location corresponding to the fourth barrier rib 284. As a result, the protrusion portions of the first electrode 221 and the protrusion portions of the fourth electrode 224 are symmetrically disposed at the first discharge region 291, and the protrusion portions of the second electrode 222 and the protrusion portions of the third electrode 223 are symmetrically disposed at the second discharge region 292.

However, due to a misalignment between the first through fourth electrodes 221, 222, 223, and 224 and the first through fourth barrier ribs 281 through 284, respective areas of the first through fourth electrodes 221, 222, 223, and 224 exposed in (or at) the first and second discharge regions 291 and 292 can be different. More specifically, a first area, which is an area of the first electrode 221 exposed in the first discharge region 291, can be different from (e.g., larger or smaller than) a second area, which is an area of the second electrode 222 exposed in the second discharge region 292. When the misalignment, as described above, is severe, the second electrode 222 can become exposed in the non-discharge region 293.

In particular, when the number of pixels is increased in order to realize a full high definition (FHD) image quality, a cell pitch is reduced, and thus, the misalignment can frequently occur. For example, if the first area is larger than the second area, that is, a portion (e.g., a considerable portion) of the second electrode 222 is covered by the second barrier rib 282, the discharge characteristics of the first discharge region 291 become superior to those of the second discharge region 292, and thus, a non-uniform discharge on every other line occurs. In contrast, the second area can be larger than the first area. Here, a non-uniform discharge in every other line can similarly be caused.

Also, if a portion of the fourth electrode 224 is covered by the fourth barrier rib 284, a fourth area which is an area of the fourth electrode 224 exposed at the first discharge region 291 can be smaller than a third area which is an area of the third electrode 223 exposed in the second discharge region 292.

In a PDP according to one embodiment, a first width W1 of the first barrier rib 281 corresponding to the first electrode 221 and a second width W2 of the second barrier rib 282 corresponding to the second electrode 222 are formed to be relatively small. More specifically, when the third barrier rib 283 corresponding to the third electrode 223 has a third width W3 and the fourth barrier rib 284 corresponding to the fourth electrode 224 has a fourth width W4, the first width W1 is formed to be smaller than the fourth width W4, and the second width W2 is formed to be smaller than the third width W3. In one embodiment, the first width W1 can be formed to be equal to the second width W2, and/or the third width W3 can be formed to be equal to the fourth width W4.

Therefore, the area of the second electrode 222 covered by the second barrier rib 282 can be reduced. That is, occurrences of the non-uniform discharge between the first discharge region 291 and the second discharge region 292 can be prevented (or reduced) by reducing the difference in size between the first area of the first electrode 221 exposed in the first discharge region 291 and the second area of the second electrode 222 exposed in the second discharge region 292.

More specifically, since the first electrode 221 and the second electrode 222 correspond to Y electrodes that generate reset discharges and address discharges, a non-uniformity of the reset discharges and the address discharges can be prevented (or reduced) by reducing the difference in size between the first area of the first electrode 221 exposed in the first discharge region 291 and the second area of the second electrode 222 exposed in the second discharge region 292.

The phosphor layer 277 (see, for example, FIG. 2) emits R, G and B visible light by receiving vacuum ultraviolet rays generated due to the discharge. In one embodiment, the phosphor layer 277 includes a red light emitting layer 277R formed of Y(V,P)O₄:Eu, a green light emitting layer 277G formed of Zn₂SiO₄:Mn or YBO₃:Tb, and a blue light emitting layer 277B formed of BAM:Eu.

The first and second discharge regions 291 and 292 are filled with a discharge gas such as Ne gas, Xe gas, or He gas, or a mixture of these gases.

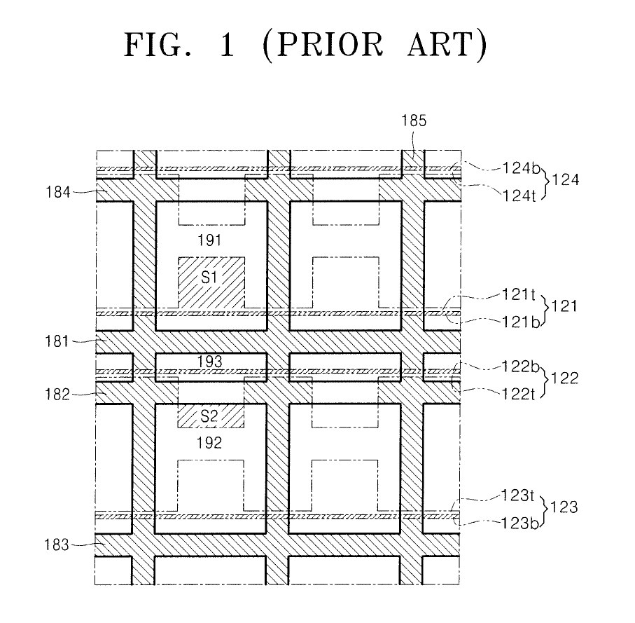

Hereinafter, the improvement of non-uniform discharge characteristics in every other line of a PDP according to an embodiment of the present invention is presented. The conventional PDP has barrier ribs having equal width as depicted in FIG. 1. In a PDP according to an embodiment of the present invention, widths of a first barrier rib and a second barrier rib are formed smaller than widths of a third barrier rib and a fourth barrier rib, the width of the first barrier rib is formed to be equal to the width of the second barrier rib, and the width of the third barrier rib is formed to be equal to the width of the fourth barrier rib. Discharge cells that generate a non-uniform discharge in every other line were visually observed by driving the PDP according to the present embodiment and the conventional PDP at room temperature (25° C.), low temperature (−5° C.), and high temperature (55° C.), respectively. The results are summarized in Table 1. The numbers in Table 1 are the percentage ratios of discharge cells that generate a non-uniform discharge in every other line with respect to all discharge cells.

TABLE 1

| | | PDP of present embodiment |
|---|---|---|
| Temperatures | Conventional PDP (%) | (%) |
| Room temperature | 4.3 | 0.9 |
| Low temperature | 28 | 7.2 |
| High temperature | 16 | 3.4 |

Referring to Table 1, it is seen that the PDP according to the present invention has a reduced non-uniform discharge ratio of more than 3 percentage points. In particular, at low temperature, the reduction is more than 20 percentage points lower than the conventional PDP.

As described above, embodiments of the present invention provide a PDP having double barrier ribs to form non-discharge regions between the discharge regions. Thus, the exhaustion of a discharge can be effectively performed.

Also, since discharge electrodes are formed on the double barrier ribs and, in particular, the discharge electrodes, to which substantially identical voltage waveforms are applied during a sustain period, are respectively disposed on the adjacent barrier ribs, the power consumption of the PDP can be reduced. For example, Y electrodes or X electrodes are respectively disposed on the adjacent barrier ribs that form the non-discharge regions, thereby reducing the power consumption of the PDP.

In embodiments of the present invention, since widths of the first and second barrier ribs that correspond to the Y electrodes are formed relatively smaller than widths of the third and fourth barrier ribs that correspond to the X electrodes, a difference in size between the areas of the discharge electrodes exposed in the first and second discharge regions can be reduced when a misalignment of the discharge electrodes with respect to the barrier ribs occurs. Accordingly, the occurrences of a non-uniform discharge in every other line due to such a difference in size can be reduced, thereby increasing the reliability of the PDP.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A plasma display panel comprising:
a first substrate and a second substrate facing the first substrate, the first and second substrates defining a discharge space therebetween; and
a plurality of barrier ribs between the first and second substrates and defining a plurality of non-discharge regions and a plurality of discharge regions at the discharge space,
wherein the barrier ribs comprise:
a plurality of first barrier ribs and a plurality of second barrier ribs adjacent to the first barrier ribs, the first and second barrier ribs defining the non-discharge regions;
a plurality of third barrier ribs adjacent to the second barrier ribs, the second and third barrier ribs defining first discharge regions of the discharge regions, the first discharge regions being adjacent to the non-discharge regions, and the third barrier ribs having a width different from a width of the second barrier ribs; and
a plurality of fourth barrier ribs adjacent to the first barrier ribs, the first and fourth barrier ribs defining second discharge regions of the discharge regions, the second discharge regions being adjacent to the non-discharge regions, and the fourth barrier ribs having a width different from a width of the first barrier ribs.

2. The plasma display panel of claim 1, wherein the width of the first barrier ribs is smaller than the width of the fourth barrier ribs.

3. The plasma display panel of claim 1, wherein the width of the second barrier ribs is smaller than the width of the third barrier ribs.

4. The plasma display panel of claim 1, wherein the width of the first barrier ribs and the width of the second barrier ribs are substantially equal to each other.

5. The plasma display panel of claim 1, wherein the first barrier ribs, the second barrier ribs, the third barrier ribs, and the fourth barrier ribs are in parallel to each other.

6. The plasma display panel of claim 1, wherein the barrier ribs further comprise a plurality of fifth barrier ribs crossing the first barrier ribs, the second barrier ribs, the third barrier ribs, and the fourth barrier ribs.

7. A plasma display panel comprising:
a first substrate and a second substrate facing the first substrate, the first and second substrates defining a discharge space therebetween;
a plurality of barrier ribs between the first and second substrates and defining a plurality of non-discharge regions and a plurality of discharge regions at the discharge space; and
a plurality of discharge electrodes for generating discharges at the discharge regions in accordance with an applied voltage,
wherein the plurality of barrier ribs comprise:
a plurality of first barrier ribs and a plurality of second barrier ribs adjacent to the first barrier ribs, the first and second barrier ribs defining the non-discharge regions;
a plurality of third barrier ribs adjacent to the second barrier ribs, the second and third barrier ribs defining first discharge regions of the discharge regions, the first discharge regions being adjacent to the non-discharge regions, and the third barrier ribs having a width different from a width of the second barrier ribs; and
a plurality of fourth barrier ribs adjacent to the first barrier ribs, the first and fourth barrier ribs defining second discharge regions of the discharge regions, the second discharge regions being adjacent to the non-discharge regions, and the fourth barrier ribs having a width different from a width of the first barrier ribs, and
wherein the plurality of discharge electrodes comprise:
a plurality of first discharge electrodes for generating the discharges at the first discharge regions; and
a plurality of second discharge electrodes for generating the discharges at the second discharge regions, the second discharge electrodes being in parallel to the first discharge electrodes,
wherein portions of the first discharge electrodes exposed at the first discharge regions have a size different from a size of portions of the second discharge electrodes exposed at the second discharge regions.

8. The plasma display panel of claim 7, wherein the width of the first barrier ribs is smaller than the width of the fourth barrier ribs.

9. The plasma display panel of claim 7, wherein the width of the second barrier ribs is smaller than the width of the third barrier ribs.

10. The plasma display panel of claim 7, wherein substantially identical voltage waveforms are applied to the first and second discharge electrodes during a sustain period.

11. The plasma display panel of claim 7, wherein portions of the second discharge electrodes are exposed at the non-discharge regions.

12. The plasma display panel of claim 7, wherein the plurality of discharge electrodes further comprise a plurality of third discharge electrodes for generating the discharges at the second discharge regions, and wherein the applied voltage is alternately applied to the second discharge electrodes and the third discharge electrodes.

13. The plasma display panel of claim 12, wherein the first discharge electrodes comprise a first plurality of scan electrodes, and wherein the second discharge electrodes comprise a second plurality of scan electrodes.

14. The plasma display panel of claim 13, wherein the third discharge electrodes comprise a plurality of sustain electrodes.

15. The plasma display panel of claim 12, wherein the plurality of discharge electrodes further comprise a plurality of fourth discharge electrodes for generating the discharges at the first discharge regions, and wherein the applied voltage is alternately applied to the first discharge electrodes and the fourth discharge electrodes.

16. The plasma display panel of claim 15, wherein the third discharge electrodes comprise a first plurality of sustain electrodes, and wherein the fourth discharge electrodes comprise a second plurality of sustain electrodes.

17. The plasma display panel of claim 16, wherein the first discharge electrodes comprise a first plurality of scan electrodes, and wherein the second discharge electrodes comprise a second plurality of scan electrodes.

18. The plasma display panel of claim 15, wherein portions of the third discharge electrodes exposed at the second discharge regions have a surface area different from a surface area of portions of the fourth discharge electrodes exposed at the first discharge regions.
